(19) United States
(12) Patent Application Publication
(10) Pub. No.: US 2026/0358835 A1
(43) Pub. Date: Nov. 12, 2026

(54) METHODS, NETWORK ENTITIES AND CONTROL UNITS FOR HANDLING LAWN MOWERS WITH ABNORMAL BEHAVIOR

(71) Applicant: Greenworks (Jiangsu) Co., Ltd, Changzhou (CN)

(72) Inventor: Maria Kroll, Jonkoping (SE)

(21) Appl. No.: 19/712,128

(22) Filed: Jun. 18, 2026

Related U.S. Application Data
(63) Continuation of application No. PCT/CN2023/140964, filed on Dec. 22, 2023.

(51) Int. Cl. G05D 1/698; A01D 34/00; A01D 101/00; G05D 1/648; G05D 1/86; G05D 105/15; G05D 107/20

(52) U.S. Cl. CPC G05D 1/6987; A01D 34/008; G05D 1/6482; G05D 1/86; A01D 2101/00; G05D 2105/15; G05D 2107/23

(57) ABSTRACT

A method performed by a network entity (120) for handling a first lawn mower (114) with abnormal behavior is disclosed. The method comprises: obtaining (202) information associated to a first lawn mower (114) among the multiple lawn mowers (112, 114, 116), the information associated to the first lawn mower (114) comprises an indication of abnormal behavior and working status, the working status comprises working progress information of the first lawn mower (114) when the first lawn mower (114) behaves abnormal; determining (204) an updated working plan based on the information associated to the first lawn mower (114), wherein the updated working plan relates to at least one of the multiple lawn mowers (112, 116) excluding the first lawn mower (114); sending (206) the updated working plan to the at least one of the multiple lawn mowers (112, 116) excluding the first lawn mower (114).

### CROSS REFERENCE TO RELATED APPLICATIONS

The present application is a Continuation Application of PCT Application No. PCT/CN2023/140964 filed on Dec. 22, 2023, the contents of which are incorporated herein by reference in their entirety.

### TECHNICAL FIELD

The present disclosure relates generally to methods, network entities and control units for handling lawn mowers with abnormal behavior. The present disclosure also relates to lawn mower, computer program and carrier which relate to the methods, network entities and controls units for handling lawn mowers with abnormal behavior.

### BACKGROUND

When a lawn mower is working on its working area, it is possible that the lawn mower has abnormal behavior. The reason for abnormal behavior can be e.g., the lawn mower meets with an obstacle, the lawn mower has problem in its hardware or software, etc. The abnormal behavior prevents the lawn mower to finish its work on the working area, i.e., cannot finish mowing the grass in the working area. In a scenario that there are multiple lawn mowers working in a large area and each lawn mower is assigned a dedicated working area, when one lawn mower has abnormal behavior and cannot finish its work in its working area, an unevenly mowed large area is resulted. This is usually not desirable.

Therefore, there is a need for a solution to handle the situation when one lawn mower has abnormal behavior. Furthermore, there is also a need for a solution to finish the work for the abnormal lawn mower.

### SUMMARY

It is an object of the invention to address at least some of the problems and issues outlined above. It is an object of embodiments of the invention to handle the lawn mower with abnormal behavior. Furthermore, it is also an object of embodiments of the invention to finish the work for the abnormal lawn mower. It is possible to achieve the object and possibly others by providing the methods and control units as defined in the attached claims.

In a first aspect of the invention, a method performed by a network entity for handling a first lawn mower with abnormal behavior is disclosed. The network entity is arranged for communicating with multiple lawn mowers working in a predefined area, each of the multiple lawn mowers is arranged for working in a dedicated working area according to a predefined working plan, the method comprises: obtaining information associated to a first lawn mower among the multiple lawn mowers, the information associated to the first lawn mower comprises an indication of abnormal behavior and working status, the working status comprises working progress information of the first lawn mower when the first lawn mower behaves abnormal; determining an updated working plan based on the information associated to the first lawn mower, wherein the updated working plan relates to at least one of the multiple lawn mowers excluding the first lawn mower; sending the updated working plan to the at least one of the multiple lawn mowers excluding the first lawn mower.

In a second aspect of the invention, a method performed by a control unit of a first lawn mower for informing about abnormal behavior of the first lawn mower is disclosed. The control unit is arranged for communicating with a network entity, the first lawn mower is arranged for working in a dedicated working area according to a predefined working plan, the method comprises: sending information associated to the first lawn mower to the network entity when the first lawn mower behaves abnormal, the information associated to the first lawn mower comprises an indication of abnormal behavior and working status, the working status comprises working progress information of the first lawn mower when the first lawn mower behaves abnormal.

In a third aspect of the invention, a network entity for handling a first lawn mower with abnormal behavior is disclosed. The network entity comprises a processing circuitry and a memory, the memory containing instructions executable by the processing circuitry, the network entity is arranged for communicating with multiple lawn mowers working in a predefined area, each of the multiple lawn mowers is arranged for working in a dedicated working area according to a predefined working plan, the network entity is operative for performing any one of the methods defined above.

In a fourth aspect of the invention, discloses a computer program comprising instructions, which, when executed by a processing circuitry of a network entity, controlling the network entity for handling a first lawn mower with abnormal behavior, causes the network entity to perform any one of the methods as defined above.

In a fifth aspect of the invention, discloses a carrier containing the computer program according to above, wherein the carrier is one of an electronic signal, an optical signal, a radio signal, an electric signal, or a computer readable storage medium.

In a sixth aspect of the invention, a control unit of a first lawn mower for informing about abnormal behavior of the first lawn mower, the control unit comprises a processing circuitry and a memory, the memory containing instructions executable by the processing circuitry, wherein the control unit is arranged for communicating with a network entity, the first lawn mower is arranged for working in a dedicated working area according to a predefined working plan, the control unit is operative for performing any one of the methods as defined above.

In a seventh aspect of the invention, a computer program comprising instructions, which, when executed by a processing circuitry of a control unit, controlling the control unit for informing about abnormal behavior of the first lawn mower, causes the control unit to perform any one of the methods as defined above.

In an eighth aspect of the invention, discloses a carrier containing the computer program according to above, wherein the carrier is one of an electronic signal, an optical signal, a radio signal, an electric signal, or a computer readable storage medium.

In a nineth aspect of the invention, discloses a first lawn mower comprising the control unit as defined above.

### BRIEF DESCRIPTION OF DRAWINGS

The invention is now described, by way of example, with reference to the accompanying drawings, in which:

FIG. 1 schematically shows a layout of a predefined area and multiple lawn mowers working thereon, according to possible embodiments.

FIG. 2 schematically shows a flow chart of a method performed by a network entity for handling lawn mower with abnormal behavior, according to possible embodiments.

FIG. 3 schematically shows a flow chart of a method performed by a control unit of a lawn mower for informing about abnormal behavior, according to possible embodiments.

FIG. 4 schematically shows one way for handling unfinished work of a lawn mower with abnormal behavior, according to possible embodiments.

FIG. 5 schematically shows another way for handling unfinished work of a lawn mower with abnormal behavior, according to possible embodiments.

FIG. 6 schematically shows the control unit arranged on a lawn mower.

FIG. 7 schematically shows the network entity in detail, according to possible embodiments.

FIG. 8 schematically shows the control unit in detail, according to possible embodiments.

### DETAILED DESCRIPTION

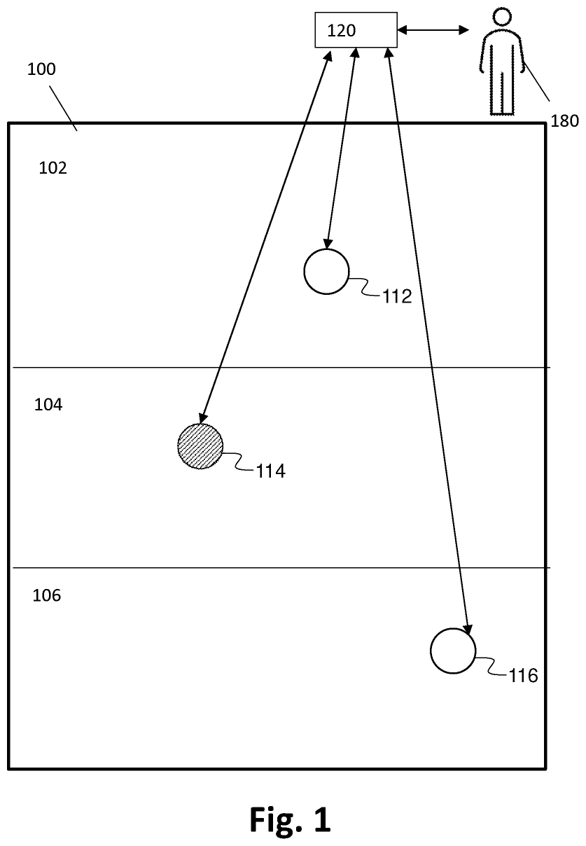

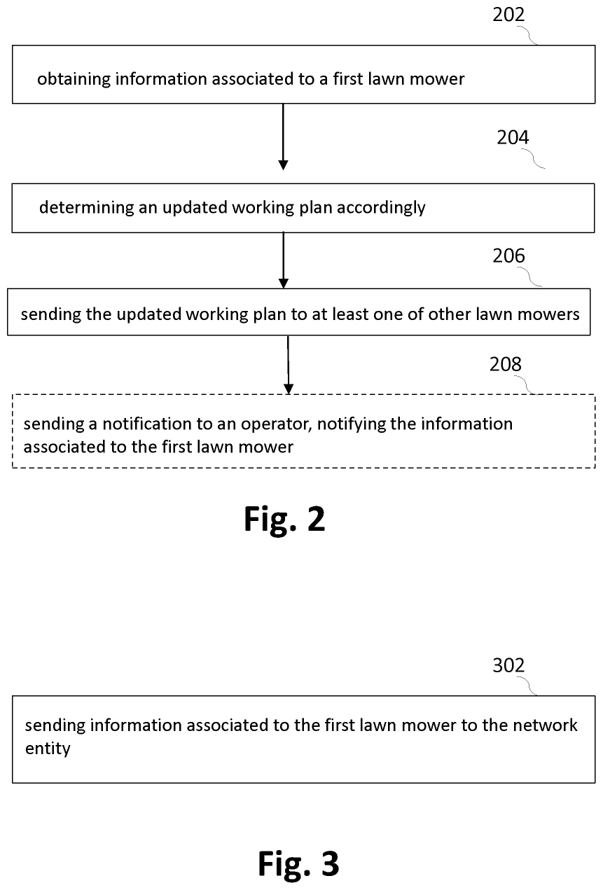

Referring to FIG. 1, multiple lawn mowers 112, 114, 116 are arranged to work in a predefined area 100. Each of the lawn mowers 112, 114, 116 is arranged for working in a dedicated working area 102, 104, 106, i.e., the lawn mower 112 is arranged with the working area 102, the lawn mower 114 is arranged with the working area 104, the lawn mower 116 is arranged with the working area 106. A network entity 120 is arranged for communicating with the multiple lawn mowers 112, 114, 116. The network entity 120 can be a server, a cloud device, etc., as long as it communicatively connected to the multiple lawn mowers 112, 114, 116 and have calculating capacity.

The basic idea of this invention is that when a first lawn mower 114 has abnormal behavior, the network entity 120 obtains information associated to the first lawn mower 114. The information associated to the first lawn mower 114 comprises an abnormal behavior indication and working status of the first lawn mower 114. Based on the information associated to the first lawn mower 114, the network entity 120 updates a working plan for at least one of the normal lawn mowers 112, 116, so that the at least one of normal the lawn mowers 112, 116 is arranged to take over the work of the first lawn mower 114. Therefore, the work in the whole predefined area 100 is not negatively affected by the abnormal lawn mower 114.

According to one embodiment, referring to FIG. 1, and 2, a method performed by a network entity 120 for handling a lawn mower with abnormal behavior is disclosed. The network entity 120 is arranged for communicating with multiple lawn mowers 112, 114, 116 working in a predefined area 100, each of the multiple lawn mowers 112, 114, 116 is arranged for working in a dedicated working area 102, 104, 106 according to a predefined working plan, the method comprises: obtaining 202 information associated to a first lawn mower 114 among the multiple lawn mowers 112, 114, 116, the information associated to the first lawn mower 114 comprises an indication of abnormal behavior and working status, the working status comprises working progress information of the first lawn mower 114 when the first lawn mower 114 behaves abnormal; determining 204 an updated working plan based on the information associated to the first lawn mower 114, wherein the updated working plan relates to at least one of the multiple lawn mowers 112, 116 excluding the first lawn mower 114; sending 206 the updated working plan to the at least one of the multiple lawn mowers 112, 116 excluding the first lawn mower 114.

In this embodiment, each of the lawn mower 112, 114, 116 is arranged for working in a dedicated working area 102, 104, 106 according to a predefined working plan. In the step 202, the network entity 120 obtains information associated to the first lawn mower 114 which is abnormal. The information associated to the first lawn mower 114 comprises an indication of abnormal behavior and working status. The indication of abnormal behavior is used to inform the network entity 120 that the first lawn mower 114 is abnormal now. The working status also comprises working progress information of the first lawn mower 114 when it behaves abnormal, so that the network entity 120 knows the working progress of the first lawn mower 114. The working status can further comprise other working status of the first lawn mower 114, e.g., identity of the first lawn mower 114, model of the first lawn mower 114, abnormal type, position of the first lawn mower 114, etc.

In the step 204, the network entity 120 determines an updated working plan based on the obtained information associated to the lawn mower 114, for example, the updated working plan instructs the normal lawn mowers 112, 116 to work on the working area 104 to finish the unfinished work of the first lawn mower 104. This will be discussed in detail in the following text. The updated working plan relates to at least one of the multiple lawn mowers 112, 116 excluding the first lawn mower 114, i.e., the updated working plan can relate to one normal lawn mower 112 or 116, or can related to both of the normal lawn mowers 112, 116.

In the step 206, the updated working plan is sent by the network entity 120 to the normal lawn mowers 112, 116 which are involved in the updated working plan, so that the lawn mowers 112, 116 can follow the updated working plan.

By this method, the abnormal state of the first lawn mower 114 is informed to the network entity 120. Based on the working progress information of the first lawn mower 114, an accurate updated working plan can be determined, and the normal lawn mowers 112, 116 can finish the work on the whole predefined area 100.

According to another embodiment, the working progress information comprises the area which has been mowed by the first lawn mower 114 and/or the area which needs to be mowed by the first lawn mower 114 according to the predefined working plan when the first lawn mower 114 behaves abnormal.

In this embodiment, the information of the area which has been mowed by the first lawn mower 114 and/or the area which needs to be mowed by the first lawn mower 114 is informed to the network entity 120 in the working progress information. Therefore, the network entity 120 can determine an accurate updated working plan for other normal lawn mowers 112, 114, e.g., for the area which has already been mowed by the first mower 114, the network entity 120 does not need to arrange any other lawn mower to work on it; for the area which needs to be mowed by the first lawn mower 114, the network entity 120 can determine how the normal lawn mowers 112, 116 can take over the work on the area. The area which has been mowed by the first lawn mower 114 and/or the area which needs to be mowed by the first lawn mower 114 can be indicated by working time or planed working time of the first lawn mower 114. Since the working speed of the lawn mower 114 is known, the area which has been mowed by the first lawn mower 114 is proportional to the working time before the first lawn mower 114 becomes abnormal. The area which needs to be mowed by the first lawn mower 114 is proportional to the planed working time after the first lawn mower 114 becomes abnormal.

According to another embodiment, the obtaining 202 of the information associated to the first lawn mower 114 further comprises: sending status checking messages to each of the multiple lawn mowers 112, 114, 116; generating the indication of abnormal behavior when not receiving a reply of the status checking message from the first lawn mower 114.

This embodiment defines one way of the network entity 120 obtaining the indication of abnormal behavior. In this embodiment, the network entity 120 continually sends status checking messages to each of the lawn mowers 112, 114, 116. The sending of the status checking messages can be at a predefined pace, e.g., every 2 seconds, every 1 minute, etc. If the lawn mowers 112, 114, 116 are normal, each of them will reply the status checking message to the network entity 120. When the first lawn mower 114 becomes abnormal, it will not reply the status checking message from the network entity 120. Therefore, when the network entity 120 does not receiving the reply of the status checking message from the first lawn mower 114, the network entity 120 determines that the first lawn mower 114 is abnormal and generates the indication of abnormal behavior, which is comprised in the information associated to the first lawn mower 114. As for the working status, the network entity 120 can use previous working status which was received latest from the first lawn mower 114 before it became abnormal.

According to another embodiment, the obtaining 202 of the information associated to the first lawn mower 114 further comprises: generating the indication of abnormal behavior when not receiving any information from the first lawn mower 114 for a predefined time period.

This embodiment defines another way of the network entity 120 obtaining the indication of abnormal behavior. Normal lawn mowers 112, 114, 116 communicates with the network entity 120 periodically, e.g., sends its working status regularly to the network entity 120. Therefore, when the network entity 120 does not receive any information from the first lawn mower 114 for a predefined time period, the network entity 120 determines that the first lawn mower 114 becomes abnormal and generates the indication of abnormal behavior. The network entity 120 can use previous working status which was received latest from the first lawn mower 114 before it became abnormal.

According to another embodiment, the obtaining 202 of the information associated to the first lawn mower 114 further comprises: receiving the information associated to the first lawn mower 114 from the first lawn mower 114.

In this embodiment, the first lawn mower 114 actively sends the information associated to the first lawn mower 114 to the network entity 120 when it becomes abnormal. The network entity 120 can use the information associated to the first lawn mower 114 received from the first lawn mower 114 when determining the updated working plan.

According to another embodiment, the determining 204 of the updated working plan further comprises allocating the working area 104 of the first lawn mower 114 to the at least one of the multiple lawn mowers 112, 116 excluding the first lawn mower 114.

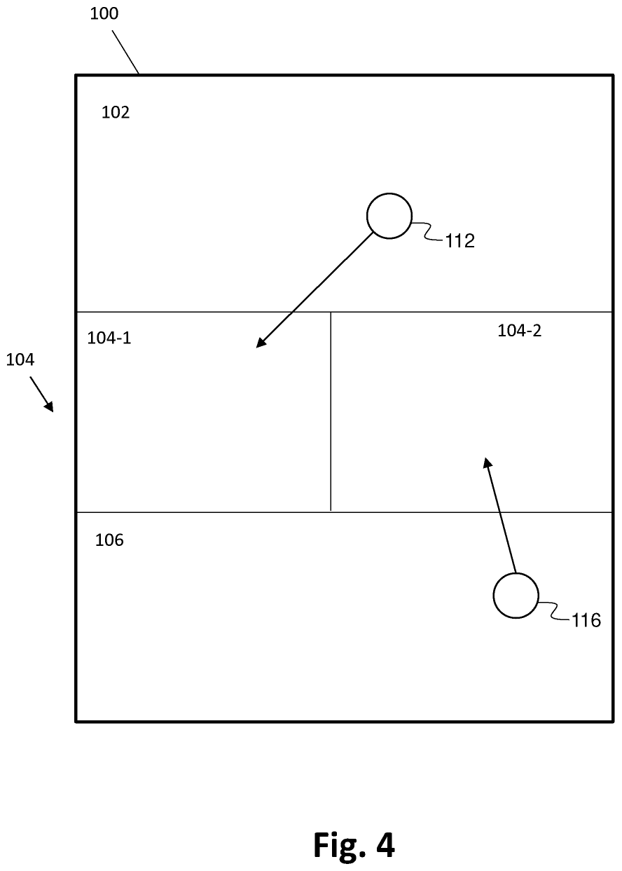

In this embodiment, referring to FIG. 4 the working area 104 of the first lawn mower 114 is reallocated to the at least one of the normal lawn mowers 112, 116. For example, each of the lawn mowers 112, 116 can take over half of the working area 104, namely 104-1 and 104-2, or only one lawn mower 112 or 116 takes over the working area 104. In another example, only the unmowed part in the working area 104 is reallocated to the at least one of the normal lawn mowers 112, 116.

According to another embodiment, the determining 204 of the updated working plan further comprises reallocating the predefined area 100 to the at least one of the multiple lawn mowers 112, 116 excluding the first lawn mower 114.

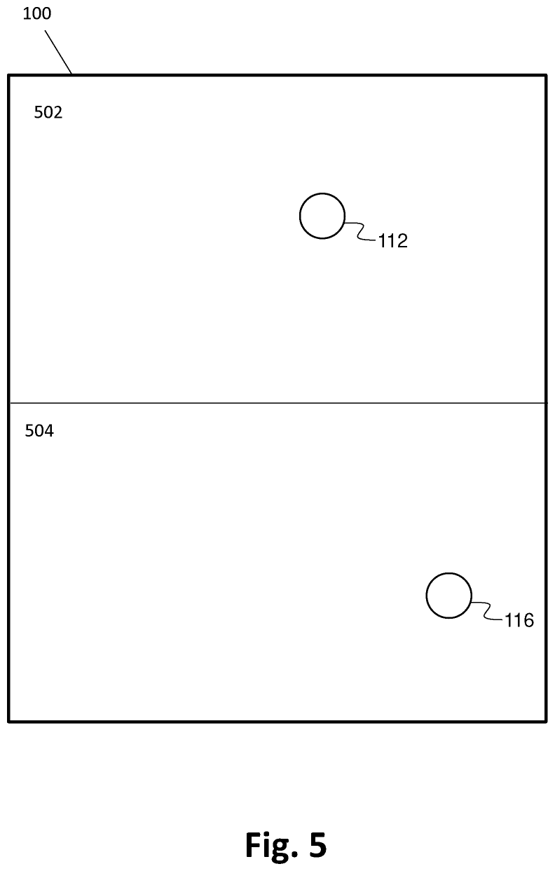

In this embodiment, referring to FIG. 5, the whole predefined area 100 is reallocated to at least one of the normal lawn mowers 112, 116. For example, the predefined area 100 is redivide into two working areas 502 and 504. Each of the two working areas 502 and 504 are allocated to the lawn mower 112 and lawn mower 116 respectively. Alternatively, only unmowed part of the predefined area 100 is reallocated to the at least one of the normal lawn mowers 112, 116.

According to another embodiment, the method further comprises: sending 208 a notification to an operator 180, notifying the operator 208 about the information associated to the first lawn mower 114.

In this embodiment, referring to FIG. 1, an operator 180 is involved. The network entity 120 can send a notification to the operator 180, so that the operator 180 is aware of the information associated to the first lawn mower 114, i.e., the operator 180 knows that the first lawn mower 114 is abnormal, and the operator also knows the working status of the first lawn mower 114.

According to another embodiment, if the determined 206 updated working plan exceeds the maximum capacity of any one of the at least one multiple lawn mowers 112, 116 excluding for the first lawn mower 114, the notification to the operator 180 includes information about that the maximum capacity has been exceeded.

In this embodiment, the maximum capacity of any one of the normal lawn mowers 112, 116 is considered. Since the lawn mowers 112, 116 can be reallocated to a larger working area than the original working plan, it is possible that the maximum capacity of any one of the lawn mowers 112, 116 is exceeded according to the updated working plan. In this situation, the operator 180 is informed about this, so that the operator 180 has the possibility to change the updated working plan.

According to another embodiment, a method performed by a control unit 130 of a first lawn mower 114 for informing about abnormal behavior of the first lawn mower 114 is disclosed. The control unit 130 is arranged for communicating with a network entity 120, the first lawn mower 114 is arranged for working in a dedicated working area 104 according to a predefined working plan, referring to FIG. 3, the method comprises: sending 302 information associated to the first lawn mower 114 to the network entity 120, when the first lawn mower 114 behaves abnormal, the information associated to the first lawn mower 114 comprises an indication of abnormal behavior and working status, the working status comprises working progress information of the first lawn mower 114 when the first lawn mower 114 behaves abnormal.

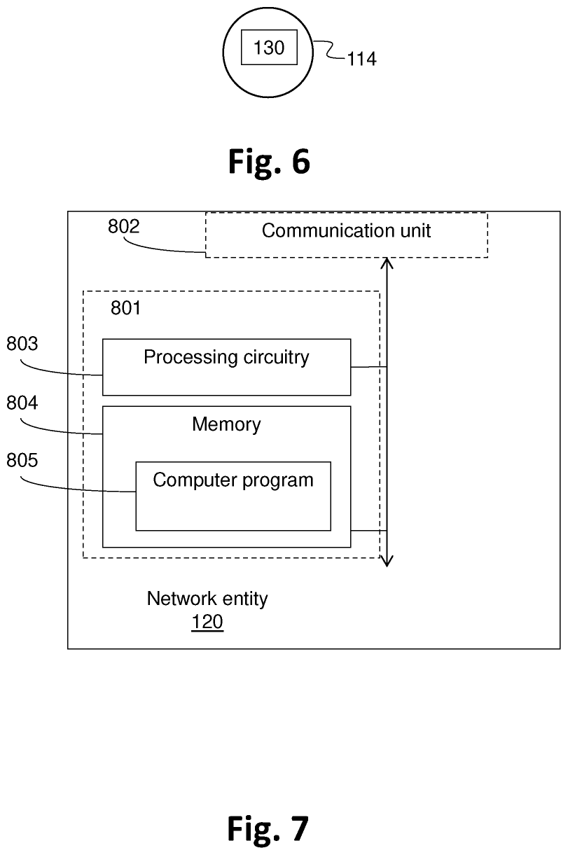

Referring to FIG. 6, this embodiment defines a control unit 130 which is arranged on a lawn mower 114. Please note that FIG. 6 only shows the first lawn mower 114, however any of the lawn mowers 112, 114, 116 can be equipped with the control unit 130 to deal with possible abnormal situation.

When the first lawn mower 114 behaves abnormal, the control unit 130 sends the information associated to the first lawn mower 114 to the network entity 120, so the network entity 120 is aware of the status of the first lawn mower 114 and can react accordingly. The information associated to the first lawn mower 114 comprises an indication of abnormal behavior of the first lawn mower 114 and working status of the first lawn mower 114. The working status comprises working progress information when the first lawn mower 114 behaves abnormal. The working status can further comprise other working status of the first lawn mower 114, e.g., identity of the first lawn mower 114, model of the first lawn mower 114, abnormal type, position of the lawn mower 114, etc.

According to another embodiment, the working progress information comprises the area which has been mowed by the first lawn mower 114 and/or the area which needs to be mowed by the first lawn mower 114 according to the predefined working plan when the first lawn mower 114 behaves abnormal.

According to another embodiment, a network entity 120 for handling a first lawn mower 114 with abnormal behavior, the network entity 120 comprises a processing circuitry 803 and a memory 804, the memory 804 containing instructions executable by the processing circuitry 803, the network entity 120 is arranged for communicating with multiple lawn mowers 112, 114, 116 working in a predefined area 100, each of the multiple lawn mowers 112, 114, 116 is arranged for working in a dedicated working area 102, 104, 106 according to a predefined working plan, the network entity 120 is operative for performing any one of the methods as defined above.

According to another embodiment, a control unit 130 of a first lawn mower 114 for informing about abnormal behavior of the first lawn mower 114 is disclosed. The control unit 130 comprises a processing circuitry 903 and a memory 904, the memory 904 containing instructions executable by the processing circuitry 903, wherein the control unit 130 is arranged for communicating with a network entity 120, the first lawn mower 114 is arranged for working in a dedicated working area 104 according to a predefined working plan, the control unit 130 is operative for performing any one of the methods as defined above.

According to another embodiment, a lawn mower 114 comprises the control unit 130 as defined above.

According to other embodiments, referring to FIG. 7, the network entity 120 may further comprise a communication unit 802, which may be considered to comprise conventional means for wireless communication with other devices, such as a transceiver for wireless transmission and reception of signals. The instructions executable by said processing circuitry 803 may be arranged as a computer program 805 stored e.g. in said memory 804. The processing circuitry 803 and the memory 804 may be arranged in a sub-arrangement 801. The sub-arrangement 801 may be a micro-processor and adequate software and storage therefore, a Programmable Logic Device, PLD, or other electronic component(s)/processing circuit(s) configured to perform the methods mentioned above. The processing circuitry 803 may comprise one or more programmable processor, application-specific integrated circuits, field programmable gate arrays or combinations of these adapted to execute instructions.

The computer program 805 may be arranged such that when its instructions are run in the processing circuitry, they cause the network entity 120 to perform the steps described in any of the described embodiments of the network entity 120 and its method. The computer program 805 may be carried by a computer program product connectable to the processing circuitry 803. The computer program product may be the memory 804, or at least arranged in the memory. The memory 804 may be realized as for example a RAM (Random-access memory), ROM (Read-Only Memory) or an EEPROM (Electrical Erasable Programmable ROM). In some embodiments, a carrier may contain the computer program 805. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 804. Alternatively, the computer program may be stored on a server or any other entity to which the network entity 120 has access via the communication unit 802. The computer program 805 may then be downloaded from the server into the memory 804.

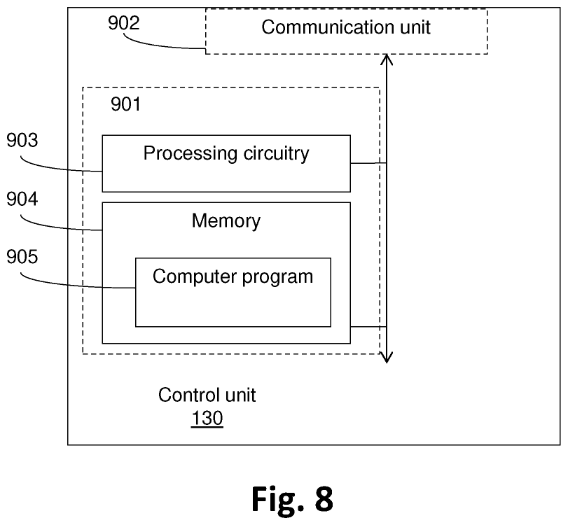

According to other embodiments, referring to FIG. 8, the control unit 130 may further comprise a communication unit 902, which may be considered to comprise conventional means for wireless communication with other devices, such as a transceiver for wireless transmission and reception of signals. The instructions executable by said processing circuitry 903 may be arranged as a computer program 905 stored e.g. in said memory 904. The processing circuitry 903 and the memory 904 may be arranged in a sub-arrangement 901. The sub-arrangement 901 may be a micro-processor and adequate software and storage therefore, a Programmable Logic Device, PLD, or other electronic component(s)/processing circuit(s) configured to perform the methods mentioned above. The processing circuitry 903 may comprise one or more programmable processor, application-specific integrated circuits, field programmable gate arrays or combinations of these adapted to execute instructions.

The computer program 905 may be arranged such that when its instructions are run in the processing circuitry, they cause the control unit 130 to perform the steps described in any of the described embodiments of the control unit 130 and its method. The computer program 905 may be carried by a computer program product connectable to the processing circuitry 903. The computer program product may be the memory 904, or at least arranged in the memory. The memory 904 may be realized as for example a RAM (Random-access memory), ROM (Read-Only Memory) or an EEPROM (Electrical Erasable Programmable ROM). In some embodiments, a carrier may contain the computer program 905. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 904. Alternatively, the computer program may be stored on a server or any other entity to which the control unit 130 has access via the communication unit 902. The computer program 905 may then be downloaded from the server into the memory 904.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a network entity (120) for handling a first lawn mower (114)
with at least one abnormal behavior, the network entity (120) being arranged for communicating with a plurality of lawn mowers (112, 114, 116) working in a predefined area (100), each of the lawn mowers (112, 114, 116) being arranged for working in a dedicated working area (102, 104, 106) according to a predefined working plan, the method comprises:
obtaining (202) information associated to the first lawn mower (114) among the lawn mowers (112, 114, 116), the information associated to the first lawn mower (114) comprising an indication of the abnormal behavior and a working status, the working status comprising a working progress information of the first lawn mower (114) when the first lawn mower (114) behaves abnormal;
determining (204) an updated working plan based on the information associated to the first lawn mower (114), wherein the updated working plan relates to at least one of the lawn mowers (112, 116); and
sending (206) the updated working plan to the at least one of the multiple lawn mowers (112, 116).

2. The method according to claim 1, wherein the working progress information comprises the area which has been mowed by the first lawn mower (114) and/or the area which needs to be mowed by the first lawn mower (114) according to the predefined working plan when the first lawn mower (114) behaves abnormal.

3. The method according to claim 2, wherein the obtaining (202) of the information associated to the first lawn mower (114) further comprises: sending status checking messages to each of the multiple lawn mowers (112, 114, 116); generating the indication of abnormal behavior when not receiving a reply of the status checking message from the first lawn mower (114).

4. The method according to claim 2, wherein the obtaining (202) of the information associated to the first lawn mower (114) further comprises: generating the indication of abnormal behavior when not receiving any information from the first lawn mower (114) for a predefined time period.

5. The method according to claim 2, wherein the obtaining (202) of the information associated to the first lawn mower (114) further comprises: receiving the information associated to the first lawn mower (114) from the first lawn mower (114).

6. The method according to claim 5, wherein the determining (204) of the updated working plan further comprises allocating the working area (104) of the first lawn mower (114) to the at least one of the multiple lawn mowers (112, 116) excluding the first lawn mower (114).

7. The method according to claim 5, wherein the determining (204) of the updated working plan further comprises reallocating the predefined area (100) to the at least one of the multiple lawn mowers (112, 116) excluding the first lawn mower (114).

8. The method according to claim 7, wherein the method further comprises: sending (208) a notification to an operator (180), notifying the operator (208) about the information associated to the first lawn mower (114).

9. The method according to claim 8, wherein if the determined (206) updated working plan exceeds the maximum capacity of any one of the at least one multiple lawn mowers (112, 116) excluding for the first lawn mower (114), the notification to the operator (180) includes information about that the maximum capacity has been exceeded.

10. A method performed by a control unit (130) of a first lawn mower (114) for informing
about abnormal behavior of the first lawn mower (114), wherein the control unit (130) is arranged for communicating with a network entity (120), the first lawn mower (114) is arranged for working in a dedicated working area (104) according to a predefined working plan, the method comprises:
sending (302) information associated to the first lawn mower (114) to the network entity (120) when the first lawn mower (114) behaves abnormal, the information associated to the first lawn mower (114) comprises an indication of abnormal behavior and working status, the working status comprises working progress information of the first lawn mower (114) when the first lawn mower (114) behaves abnormal.

11. The method according to claim 10, wherein the working progress information comprises the area which has been mowed by the first lawn mower (114) and/or the area which needs to be mowed by the first lawn mower (114) according to the predefined working plan when the first lawn mower (114) behaves abnormal.

12. A network entity (120) for handling a first lawn mower (114) with abnormal behavior, the network entity (120) comprises a processing circuitry (803) and a memory (804), the memory (804) containing instructions executable by the processing circuitry (803), the network entity (120) is arranged for communicating with multiple lawn mowers (112, 114, 116) working in a predefined area (100), each of the multiple lawn mowers (112, 114, 116) is arranged for working in a dedicated working area (102, 104, 106) according to a predefined working plan, the network entity (120) is operative for performing the method as claimed in claim 1.
